(19) United States
(12) Patent Application Publication
(10) Pub. No.: US 2014/0362786 A1
(43) Pub. Date: Dec. 11, 2014

(54) Fixed Wireless Communication With Capacity Enhanced Dynamic Power Control

(71) Applicant: MAX4G, INC., Eden Prairie, MN (US)

(72) Inventors: Vladimir Z. Kelman, Plymouth, MN (US); Anthony J. Klein, St. Paul, MN (US); Jeffrey T. Stern, Minnetonka, MN (US); Kerry M. Shore, Eden Prairie, MN (US)

(21) Appl. No.: 14/296,627

(22) Filed: Jun. 5, 2014

Related U.S. Application Data
(60) Provisional application No. 61/831,562, filed on Jun. 5, 2013.

(51) Int. Cl. H04W 52/26

(52) U.S. Cl. CPC H04W 52/262
USPC 370/329

(57) ABSTRACT

At least one remote station communicates with a base station in a fixed wireless communication network. Data is transmitted in a series of short duration data frames, at any of at least four discrete transmission power levels selected for that data frame, and using any of at least four modulation-coding levels selected for that data frame. When the amount of data being transmitted in that data frame requires the highest adequate modulation-coding level as determined by received signal quality information including signal-to-interference-and-noise ratio, data is transmitted at the highest optimal power level. When the amount of data being transmitted in that data frame requires less than the highest adequate modulation-coding level, data is transmitted at a lower modulation-coding level sufficient to transmit the amount of data for that frame and at a correspondingly reduced power level. In the preferred embodiment, both the remote station(s) and the base station(s) utilize the inventive method, and the correspondingly reduced power level is based on the decibel difference in signal quality permitted by the lower modulation-coding level.

### CROSS-REFERENCE TO RELATED APPLICATION(S)

The present application claims priority from Provisional Application No. 61/831,562, filed Jun. 5, 2013 and entitled “Capacity Enhanced Dynamic Power Control”. The contents of U.S. provisional patent application Ser. No. 61/831,562 are hereby incorporated by reference in entirety.

### BACKGROUND OF THE INVENTION

The present invention relates to communication systems used by computers and similar devices for connection to a network. In particular, the communication achieved with the present invention is useful in wireless communication between geographically fixed base stations and geographically fixed remote units, over line-of-sight and non-line-of-sight (NLoS) links traveling over street level distances (typically from 100 feet to several miles).

In many cases, service providers face a challenge extending their networks to locations that have no cost effective wire-line copper or fiber connectivity. In many of these situations, service providers utilize wireless communication equipment by setting up point-to-point and point-to-multi-point wireless links. The communication systems being considered have a plurality of base stations, each of which wirelessly communicates (or is capable of wirelessly communicating) with one or multiple remote units, all in the same general geographic territory. Each of the base stations and remote units are fixed rather than mobile, meaning that during ordinary use each remains stationary rather than being handheld. The present invention applies to both point-to-point (i.e., each base station supports only a single remote unit) and point-to-multipoint (i.e., each base station supports a plurality of remote units) fixed wireless systems. Either way, each remote unit communicates with an assigned base station unit. Fixed wireless communication systems are typically used for cellular backhaul, cellular access, campus network and other communication applications.

Frequency spectrum resources used in wireless communication are limited and therefore expensive in most geographic territories of operation. Fixed wireless communication systems desire to minimize the amount of frequency spectrum used, while achieving the maximum data throughput rate possible and thereby provide data as quickly as possible to users. The present invention is particularly intended for systems communicating such as in the sub-6 GHz range, for use in environments where fiber or microwave backhaul is neither practical nor feasible.

One contributing factor to obtaining maximum data throughput while efficiently using spectrum in a specific geographic area involves transmit power control. The usual and customary technique for transmit power control relies on measuring the receive signal strength and then adjusting the corresponding transmit power, so that the receive signal strength approaches some optimal target value. The receive signal strength is typically required to be high enough to provide a target signal-to-noise ratio, which in turn is required to support the highest target modulation level and minimal coding levels possible, in order to achieve maximum throughput rate possible for the data communications application.

To maximize efficiency of the frequency spectrum resources, fixed wireless systems typically reuse available frequency resources, i.e., have multiple devices simultaneously using the same frequency resources. Due to this frequency reuse, co-channel interference becomes a significant limiting factor in data throughput. To reduce co-channel interference, fixed wireless communication systems could reduce the transmit power to a minimal value that keeps the transmitter power below some interference threshold.

Many fixed wireless systems control the power of the transmitted signal both on downlink (transmission from the base station to the remote units) and uplink (transmission from the remote units to the base station), in order to limit the excessive power, which does not contribute to the quality of signal at the receiver. Such a reduction in transmit power results in a lower modulation level and therefore does not support the higher data throughput rates which are desired by users. Better schemes of power control can be devised to improve the system performance and overall data throughput rates in fixed wireless communication systems.

### BRIEF SUMMARY OF THE INVENTION

The present invention involves at least one remote station and a base station communicating with each other in a fixed wireless communication network. Data is transmitted in a series of short duration data frames, at any of at least four discrete transmission power levels selected for that data frame, and using any of at least four modulation-coding levels selected for that data frame. When the amount of data being transmitted in that data frame requires the highest adequate modulation-coding level, data is transmitted at the highest optimal power level. When the amount of data being transmitted in that data frame requires less than the highest adequate modulation-coding level, data is transmitted at a lower modulation-coding level sufficient to transmit the amount of data for that frame and at a correspondingly reduced power level. In the preferred embodiment, both the remote station(s) and the base station(s) utilize the inventive method, and the correspondingly reduced power level is based on the decibel difference in signal quality permitted by the lower modulation-coding level.

### BRIEF DESCRIPTION OF THE DRAWINGS

FIG. 1 is an illustration of multiple links of a wireless network communicating over the same frequency in a geographical area of close proximity.

FIG. 2 shows a series of twelve data frames in accordance with a preferred TDD embodiment of the present invention.

FIG. 3 is an example showing highest possible modulation-coding scheme level in a wireless communication link to comply with a bit error rate restriction and based upon measured signal quality, for the series of twelve data frames shown in FIG. 2.

FIG. 4 is an example showing required service level determined to transmit all of the ingress data during the transmission portion of each of the twelve data frames of FIGS. 2 and 3.

FIG. 5 is an example showing the transmission power level and MCS level used during the transmission portion of each of the twelve data frames of FIG. 2, based upon the signal quality measurements of FIG. 3 and ingress data amounts of FIG. 4.

While the above-identified drawing figures set forth a preferred embodiment, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

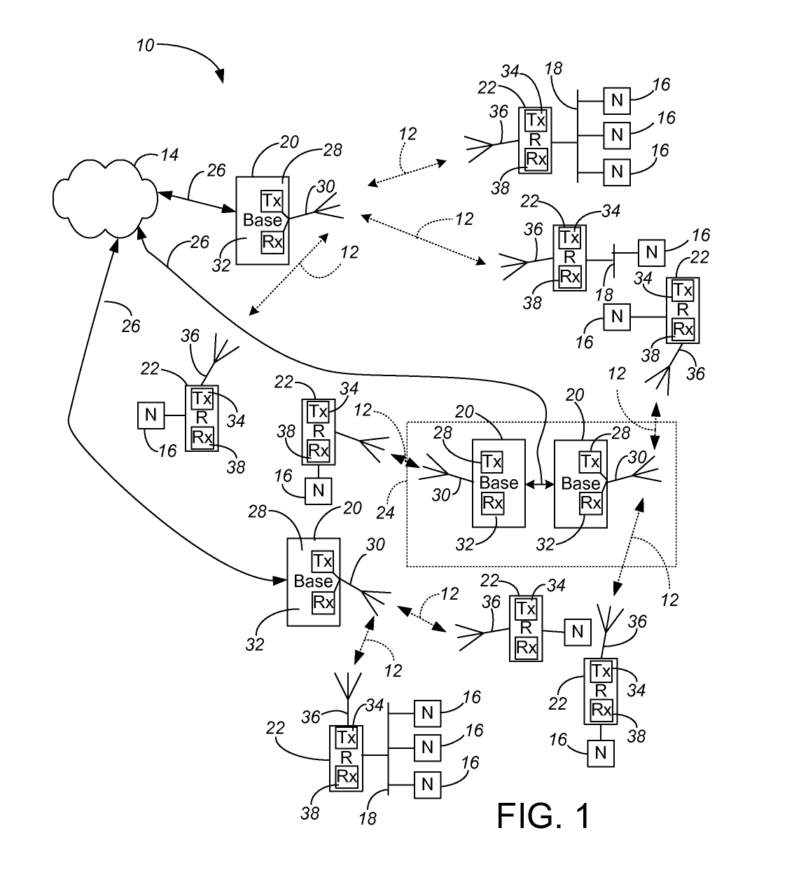

FIG. 1 shows a fixed wireless communication network 10 with plurality of point to point and/or point to multipoint links 12. The fixed wireless communication network 10 extends a service provider network 14 to various remote location nodes 16 or customer networks 18 by utilizing wireless links 12 between base stations 20 and remote units 22. The base stations 20 may be provided as one or more hubs 24 of base stations 20, or any or all base stations 20 may stand alone. Each base station 20 communicates with one or more remote units 22, all within a geographic service area. Every base station 20 is typically connected such as with a wired connection 26 to the service provider network 14, and every remote unit 22 is typically connected to an extended service provider network or customer network equipment 18, which typically includes further downstream nodes 16.

Each base station 20 has a transmitter 28 which can wirelessly send a signal through the air 12 via an antenna 30. The base station antenna 30 is preferably a directional antenna, but other antenna solutions such as antenna array, or electronically steerable smart antenna could also be used. Each base station 20 also has a receiver 32 which uses the base station antenna 30 to wirelessly receive a signal which had been transmitted such as by a remote unit 22 through the air 12. Further details about one appropriate base station architecture are described in App. No. M6.12-5, entitled “Mapping Via Back-To-Back Ethernet Switches” and assigned to the assignee of the present application, filed on even date herewith and incorporated by reference herein. Alternatively, the base station 20 could use one antenna 30 for transmission and have a separate antenna (not shown) used for reception.

Similar to the base station 20, each remote unit 22 has a transmitter 34 which can wirelessly send a signal through the air 12 via a remote unit antenna 36. The remote unit antenna 36 is preferably a directional, or electronically steerable smart antenna directed at the associated base station 20. Each remote unit 22 also has a receiver 38 which uses the remote unit antenna 36 to wirelessly receive a signal which had been transmitted such as by a base station 20 through the air 12. Alternatively, the remote unit 22 could use one antenna 36 for transmission and have a separate antenna (not shown) used for reception.

The data transmitted in either downlink or uplink is digital data as commonly used in computer systems. For instance, the transmitted data can consist of a variety of digitized information, including, but not limited to voice, video, computer files, Internet pages, etc.

Each base station 20 and remote unit 22 transmits and receives data, in both directions, via signals transmitted through the air 12. In most modern time division duplex (TDD) or frequency division duplex (FDD) data communication systems, the time of operation is divided into repetitive frames 40, with each frame 40 having a duration of less than four seconds (which is a typical time period for an Ethernet bridge level time out). Preferably the duration of each frame 40 is 20 msec or less, with the preferred embodiment utilizing data frames 40 with a duration of 1 msec. Shorter data frames could be used, but such shorter than 1 msec time frames provide very little benefit in reduced latency in TDD systems and in optimization due to varying airlink conditions while result in significantly decreased throughput due to frame control overhead and required transmit-to-receive and receive-to-transmit gap time to allow round trip signal propagation in TDD systems.

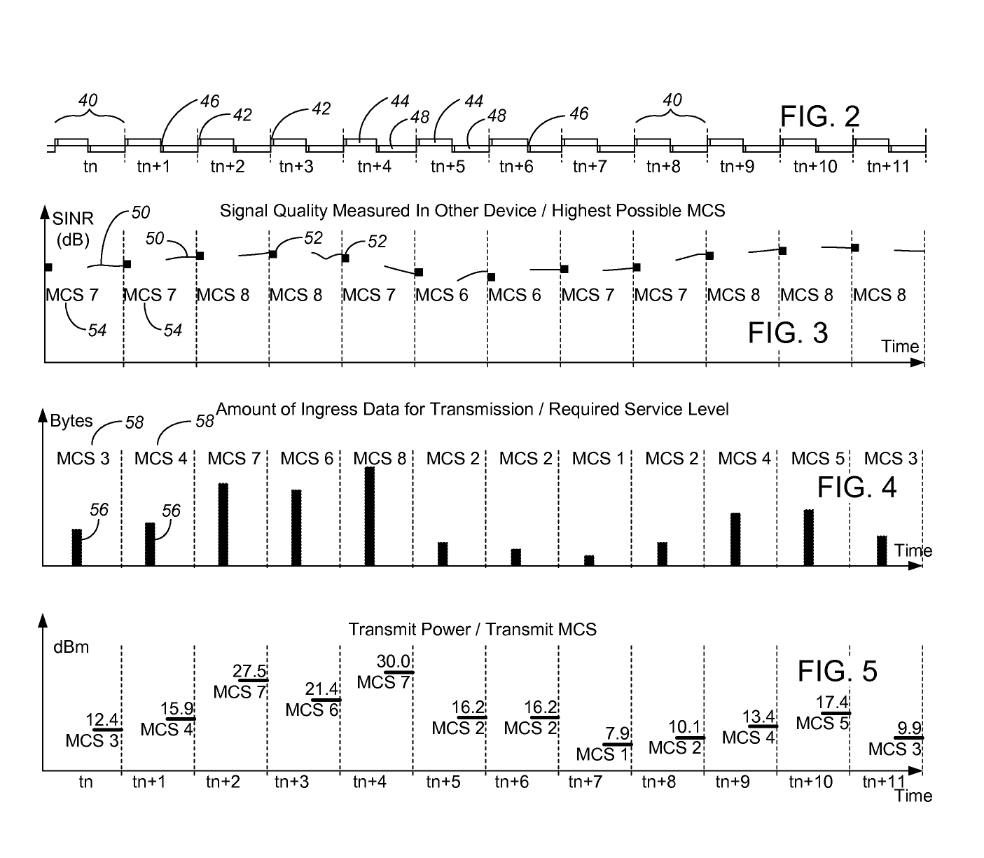

Each frame 40 typically is divided into multiple control channels and data payload channels. The preferred embodiment of the present invention uses time division duplex (TDD) with a frame duration of 1 msec, in which the frame 40 is divided into downlink control 42, downlink data 44, uplink control 46 and uplink data 48 channels as shown in FIG. 2. The downlink control 42 and the uplink control 46 are collectively referred to as the control channel. In the preferred system configuration, each transmitter 28, 34 provides control channel information 42, 46 every 1 msec at the beginning of its transmit time in the frame 40. The duration of each control channel burst is quite short, typically less than 5% of the length of the data frame 40. In other TDD and FDD systems, with different frame structures and durations, the control channel can be implemented in different ways.

To be able to effectively use the present invention, each transmitter 28, 34 can modulate and code its wireless signal under at least four modulation-coding scheme levels, each achieving a different data throughput rate. In the preferred system 10, each transmitter 28, 34 can modulate and code its wireless signal in accordance with any of nine modulation-coding scheme (“MCS”) levels shown in Table I below:

TABLE I

| MCS Level | | Coding | Throughput | SINR (dB) @ |
|---|---|---|---|---|
| Index | Modulation | Scheme | (Mbps) | 10\hat{ }−3 BER |
| 1 | QPSK | 1/2 | 28 | 2.5 |
| 2 | QPSK | 3/4 | 42 | 4.7 |
| 3 | QAM16 | 1/2 | 56 | 7.0 |
| 4 | QAM16 | 3/4 | 84 | 10.5 |
| 5 | QAM64 | 2/3 | 112 | 14.5 |
| 6 | QAM64 | 5/6 | 140 | 18.5 |
| 7 | QAM256 | 6/8 | 168 | 24.6 |
| 8 | QAM256 | 7/8 | 196 | 27.1 |
| 9 | QAM256 | 30/32 | 210 | 29.0 |

The first two MCS levels use Quadrature Phase Shift Keying (QPSK) modulation. In the third through ninth MCS levels, Quadrature amplitude modulation (QAM) is used. As shown in Table I, each MCS level results in a different data throughput rate, given approximately in million bits per second achieved by that MCS level. (The data throughput rate listed in Table I is only of the data 44, 48 transmitted in each frame 40, excluding the control information 42, 46). Thus, for example, transmission of downlink data at MCS 3 (assuming 50% downlink/50% uplink usage) permits transmission of up to about 3,500 bytes in one frame 40 (56 Mbps×0.001 s/frame×50% downlink×1/8 bytes per bit=3,500 bytes). Other frame lengths, other modulation-coding schemes and other percentages devoted to downlink and uplink can alternatively be used with the present invention, provided there are at least four different MSC levels resulting in different data throughput rates. The frame lengths and/or percentages devoted to downlink and uplink could also be dynamically controlled.

During system operation, the receivers 32, 38 of both the base stations 20 and the remote units 22 of each wireless link 12 measure signal quality. The quality of the signal determines how effectively the signal is received and accurately decoded, and the higher throughput rates of higher MCS levels require a higher signal quality. The preferred measure of signal quality includes both Signal to Interference+Noise Ratio (SINR) and Received Signal Strength Indication (RSSI). The measured SINR and RSSI values can be directly or indirectly (preferably as explained below) transmitted to the other device 20, 22 of each uplink and downlink as part of the control information 42, 46.

The final column in Table I lists the approximate SINR, in decibels, required to provide a measured bit error rate (BER) of 10⁻³ at each listed MCS level. In the preferred embodiment, a BER of 10⁻³ is considered the maximum tolerable error rate; i.e., if the SINR (dB) is lower than the value listed in Table I for any given MCS level, the preferred transmitter 28, 34 will downgrade its MCS level so as to maintain a BER for all transmissions less than 10⁻³. Alternatively, other maximum tolerable error rates could be used for determining when to switch between MCS levels, or factors other than error rate can be used to determine when a transmission is adequate for the given signal quality.

The control channel provides for a very small burst of control information 42, 46 exchanged between the two communicating devices 20, 22, once per frame 40 in each direction. Because the control channel transmissions maintain the wireless link connectivity, the control channel transmission is preferably modulated and coded with the most robust modulation. For example, MSC 1 could be used for the control channel transmission, or even a binary phase shift keying modulation could be used for the control channel transmission. Other robust modulation-coding schemes can alternatively be used for the control channel transmission.

Based on the measured SINR and RSSI values, and possibly based on other similar information, each receiving device 20, 22 determines the highest modulation-coding level at which it believes (i.e., assuming the SINR and RSSI do not change drastically) it will successfully decode data if transmitted at maximum optimal transmit power. In the preferred system 10, an Automatic Modulation Coding (AMC) mechanism at each receiver 32, 38 selects the modulation-coding level from the levels listed in Table I, referred to as the “highest possible MCS level”, which is also the highest adequate MCS level which will sustain the desired maximum BER. In other similar systems, the modulation-coding schemes utilized may be different and the AMC algorithm may be based on different measurements. The highest possible MCS level selection is transmitted to the other device 20, 22 via the control channel, thereby indirectly indicating the SINR and RSSI values measured by the receiver 32, 38. In similar systems, the highest possible MCS level can be determined by different formulas, taking into account different representations of received signal quality information, and it can be calculated on either the transmitter side or the receiver side (such as by transmitting the measured SINR and/or RSSI values directly) of the link 12. Another alternative transmits both the highest possible MCS level and the measured SINR and RSSI values of the data received in the preceding half-frame.

The highest possible MCS level is calculated frequently, such as at a minimum once every four seconds, or at least once every two hundred frames. In the preferred embodiment, the highest possible MCS level is calculated every frame 40, i.e., 1000 times per second in each device 20, 22. In the preferred embodiment, each transmission of control information includes a transmission of the highest possible MCS level for the following data frame transmission in the opposite direction.

With multiple base stations 20 and multiple remote units 22 operating in the same frequency spectrum and same geographic territory, co-channel interference is commonly present. The present invention reduces co-channel interference between the individual communication links 12. To best utilize the invention, each transmitter-receiver pair (base station—remote unit) is considered independently and can independently use the invention. That is, the transmit path from the base station 20 to the remote unit 22 is optimized by the capacity-enhanced power control of the present invention, and, in the reverse direction, the transmit path from the remote unit 22 to the base station 20 is also optimized by the capacity-enhanced power control of the present invention. Each of these control mechanisms operates independently of the other. With a single point-to-point link 12, for example, there are two instances of the capacity-enhanced power control mechanism operating: one in the downlink and one in the uplink. Alternatively, the present invention could be used in only one direction, but then only part of the benefit would be achieved. For the remainder of this description, the inventive capacity-enhanced power control mechanism is described in terms of a single direction and single transmit-receive link, despite the fact that the present invention is preferably implemented in both directions with multiple transmit-receive links operating simultaneously in each direction over the same frequency (MIMO systems).

FIG. 3 shows an example of how the highest possible MCS level may vary from one transmission time slot interval to another based on variation of measurements at the receiver 32, 38 in a Non Line of Sight (NLoS) radio channel of a fixed wireless system 10. The actual SINR 50 is continually varying based upon the conditions of the link 12 in that direction. Note that this example shows highest possible modulation-coding level in only one direction and in one of multiple transmit-receive links that can be operating simultaneously in each direction over the same frequency (MIMO systems). The highest possible modulation-coding level in the other direction or in other transmit-receive links in the same direction may be different due to link conditions and potential interference. The other device measures the actual SINR 50 and possibly other signal quality conditions and has a transmission 52 during its control channel information 42 of the highest possible MCS value 54 for use in the next data frame 48.

The transmitting device monitors the amount of data 56 arriving at its ingress data port that is to be transmitted over the airlink 12 during a subsequent time interval. The transmitting device considers this number of data bytes 56 in determining the “required service level” for the next time interval. The required service level is calculated frequently, such as at a minimum one every four seconds, or at least once every two hundred frames. In the preferred embodiment, the required service level 58 is calculated every frame 40, i.e., 1000 times per second in each device, based upon the amount of data 56 which is to be transmitted in the following transmission frame 40. FIG. 4 continues the example of FIGS. 2 and 3, showing the data bytes 56 and resultant required service level 58 required for each of the twelve data frames 40.

The preferred transmitting device uses Table I to select the minimum required service level for the next data frame 40. For example, assume the transmitting device has determined there are 5,000 bytes to be transmitted in the next data frame 40. As shown in Table 1, in a given TDD system 10 operating at 50:50 downlink to uplink ratio, a transmitting device will select MCS 4 as the required service level, since utilizing MCS 3 the transmitter 28, 34 can only send 3,500 bytes in one frame 40 and utilizing MCS 4 it can send 5,250 bytes in one frame 40.

Comparison between FIGS. 3 and 4 shows both the highest possible MCS level 54 and the required service level 58 over an example duration of twelve data frames 40. In all data frames 40 where the required service level 58 is equal to or greater than the highest possible MCS level 54, the data frame 40 will transmit at the highest possible MCS level. In our example, this occurs only in frame tn+4, when the highest possible MCS level is MCS 7 but the amount of data requires a service level of MCS 8. Utilizing the present invention, the transmitting device will transmit data frame tn+4 using full power (highest optimal power) and at MCS 7. The term “highest optimal power” is used because, while for most field conditions and for most NLoS wireless systems the best individual reception will occur when transmitting at the highest power level available, under certain field conditions that is not the case. In some system installations when there is a line of sight between the base station 20 and the remote unit 22 and/or they are installed in close proximity to each other, the signal level received by the antenna 30, 36 may be too high for receiver input, causing distortion and subsequently lower throughput performance. In such conditions, the “highest optimal transmit power level” could be lower than the maximum power level, and thereby adjust for the optimal signal input level at the receiver. The highest optimal transmit power level adjustment is typically based on the receiving unit receiver gain (usually set by automatic gain control (AGC)) control mechanism, so when the receiver gain appears too low, the transmit power is adjusted down from the maximum until the optimal receiver gain is achieved. As part of its control channel transmission 46 for frame tn+4, the transmitting device tells the receiving device that the transmit data for frame tn+4 will be transmitted at MCS 7. The excess of bytes that could not be transmitted in that specific frame tn+4 can be discarded, or more preferably is transmitted in the next frame tn+5.

For the remaining data frames 40 other than frame tn+4, the highest possible MCS level 54 exceeds the required service level 58. Instead of transmitting at the highest possible MCS level 54, the data is transmitted at the required service level 58. Not only is the data transmitted at the required service level, but the power is also correspondingly reduced for that data frame 40. In addition to transmitting at maximum power, the transmitter 28, 34 can transmit using at least three other discrete transmission power levels. More preferably, the transmitter 28, 34 can transmit at any of at least 36 discrete power levels. In the most preferred embodiment, the transmitter 28, 34 can be set to transmit at any digitally selected power level from −60 dBm up to 30 dBm in ¼ dB steps (i.e., 360 discrete power levels). Alternatively, the transmitter 28, 34 may be able to transmit at any selected power level directly selected from −60 dBm to 40.0 dBm at increments of 0.25 dBm (i.e., 400 discrete power levels). Other implementations of the invention may have a higher or lower maximum power, and may have other increments which define the various discrete transmission power levels.

In the preferred embodiment, the amount of the corresponding reduction of power level is determined based on the decibel difference in signal quality achieved by the lower modulation-coding level. So, in the example depicted in FIGS. 2-5, data frame tn has a highest possible MCS level 54 of 7 and a required service level 58 of 3. Turning to Table I, MCS 7 requires a SINR of 24.6 dB, while MCS 3 only requires a SINR of 7 dB, resulting in a difference of 17.6 dB permitted. The data transmitted in data frame tn is therefore transmitted at 17.6 dBm less than the maximum power, i.e., at 12.4 dBm (17.4 mW) assuming maximum transmit power of 30 dBm. As part of its control channel transmission 46 for frame tn, the transmitting device tells the receiving device that the transmit data for frame tn will be transmitted at MCS 3, and then transmits using MCS 3 and a power level of 17.4 mW.

Similarly, data frame tn+1 has a highest possible MCS level 54 of 7 and a required service level 58 of 4. Turning to Table I, MCS 7 requires a SINR of 24.6 dB, while MCS 4 only requires a SINR of 10.5 dB, resulting in a difference of 14.1 dB permitted. The data transmitted in data frame tn+1 is therefore transmitted at 14.1 dBm less than the maximum power, i.e., at 15.9 dBm (38.9 mW). As part of its control channel transmission 46 for frame tn+1, the transmitting device tells the receiving device that the transmit data for frame tn+1 will be transmitted using MCS 4, and then transmits at MCS 4 and a power level of 38.9 mW. Other than data frame tn+4, the power levels for all the remaining data frames 40 in the example are computed in a similar manner to determine the correspondingly reduced power level detailed in FIG. 5 for the required service level transmission.

The control channel 46 can be transmitted at full power (even when the data is transmitted at less than full power), or more preferably is transmitted at the same power level as the data portion 48 of the frame 40. The control channel information 46 indicates the power level being used for the data portion 48 of the frame 40 allowing the corresponding side to calculate the maximum possible reception MCS for the following frame.

Other methods to determine a correspondingly reduced power level could alternatively be used. For instance, the transmission power for a specific modulation could be determined directly from SINR and RSSI measurements, and based off of modulation-coding levels from previous transmissions. In similar radio systems, the modulation-coding selection algorithm can be implemented on the either side of the link when exchanging the pertinent information over the control channel.

Using the present invention continuously will result in the transmit power fluctuating dynamically largely as a function of the amount of data flowing through the link 12. As more data arrives and assuming higher power is available, the transmitter 28, 34 will respond by increasing transmit power and transferring the data at a higher modulation-coding level and, thus, a higher data rate. As the ingress data flow decreases, the transmitter 28, 34 will decrease the transmit power as a lower modulation level is adequate to transfer the data. If the system is quiescent, (i.e. no data flow), the transmit power will be reduced to the minimal value required to maintain connection. As the amount of data traffic increases, the transmit power will increase, but only to the minimal level required to support the data flow.

The preferred embodiment operates in a symmetric way between transmitter-receiver pairs on both upstream and downstream sides of every wireless link 12. In the case of a point to multipoint system 10, each link 12 is considered independently and, therefore, each base station 20 executes the preferred algorithm with every serviced remote unit 22 independently.

In systems that utilize multiple transmitters and multiple receivers such as multiple in multiple out (MIMO) or cross-polarization interference cancellation (XPIC) systems, the invention applies to each of the multiple transmit-receive paths. That is, each device runs the power reduction mechanism for each one of transmit-receive link it maintains. For example in a 2×2 MIMO point to multi point system with a base station and 3 remote units, the power reduction algorithm is independently executed on the base station 20 for each one of the 6 transmit-receive links (two transmitters, each communicating with three remote units).

Because this system 10 is distributed, with each transmit-receive path operating independently and with no centralized control, it can scale up to an unlimited number of base stations 20 and remote units 22 and has no single point of failure. Over a metropolitan or regional deployment, the overall level of interference will be reduced due to the statistical likelihood of data capacity requirements occurring in essentially random locations and at random times. The higher transmit power required to support the data capacity bursts will occur at random locations and times and, therefore, will avoid high transmit power over a large number of devices simultaneously.

Over a system 10 of many base stations 20 and remote units 22 deployed over a metropolitan area, the aggregate power consumption is minimized, because no device 20, 22 will be transmitting at higher power than the minimal amount required to maintain communication across the wireless link 12 for the amount of data transmitted in both uplink and downlink directions. For example, the twelve data frames 40 shown in FIGS. 2-5 have an average transmit power of about 16.5 dBm rather than 30 dBm. For a preferred 2×2 MIMO system (2 transmitters operating simultaneously) this reduction of transmit power creates a power consumption reduction of about 37.5 W−30.5 W=7 W, i.e., a power consumption reduction of about 19%, which is a significant savings in the cost of electricity used to run the system. The actual power consumption realized in any other system will depend upon the actual hardware components being used, the data load being transmitted in the system, the actual field conditions at the time of use, etc.

All network wireless base stations 20 and remote units 22 are utilizing downlink and uplink transmit power control for minimizing co-channel interference, in accordance with the present invention. The downlink and the uplink signals are transmitted at discrete power levels that are set to achieve the minimal required modulation-coding level that can accommodate the offered data throughput load. The invention not only optimizes the transmit power with respect to each device 20, 22, but in addition, optimizes the transmit power from a whole-system perspective, with a goal of minimizing co-channel interference in the overall network 10. The invention balances the requirement to generally operate at a minimum transmit power with the requirement to support high data communications throughput.

Although the present invention has been described with reference to preferred embodiments, workers skilled in the art will recognize that changes may be made in form and detail without departing from the spirit and scope of the invention.

What is claimed is:

1. A method of communicating between at least one remote station and a base station in a fixed wireless communication network, comprising:
providing a fixed base station having a base station wireless transmitter and a base station wireless receiver;
providing at least one fixed remote station having a remote station wireless transmitter which can wirelessly transmit data to the base station wireless receiver, the fixed remote station having a remote station wireless receiver which can wirelessly receive data from the base station wireless transmitter, with the data transmission and the data reception occurring in a series of data frames each having a duration less than four seconds;
wherein at least one of the wireless transmitters transmits at any of at least four discrete transmission power levels selected for that data frame, and using any of at least four modulation-coding levels selected for that data frame,
assessing an amount of data being transmitted in each data frame;
assessing signal quality to establish a highest modulation-coding level selected from the at least four modulation-coding levels at which data can be adequately transmitted; and
transmitting data for each data frame at a power level and modulation-coding level which:
a) when the amount of data being transmitted in that data frame requires the highest adequate modulation-coding level, is at the highest optimal power level; and
b) when the amount of data being transmitted in that data frame requires less than the highest adequate modulation-coding level, is at a lower modulation-coding level sufficient to transmit the amount of data for that frame and at a correspondingly reduced power level.

2. The method of claim 1, wherein an amount of corresponding reduction of power level is based on the decibel difference in signal quality permitted by the lower modulation-coding level.

3. The method of claim 1,
wherein both the base station wireless transmitter and the remote station wireless transmitter transmit at any of at least four discrete transmission power levels selected for that data frame, and using any of at least four modulation-coding levels selected for that data frame;
wherein the acts of assessing an amount of data being transmitted in each data frame and assessing SINR occur both in the base station and the remote station; and
wherein both the base station and the remote station transmit data for each data frame at a power level and modulation-coding level which:
a) when the amount of data being transmitted in that data frame requires the highest adequate modulation-coding level, is at the highest optimal power level; and
b) when the amount of data being transmitted in that data frame requires less than the highest adequate modulation-coding level, is at a lower modulation-coding level sufficient to transmit the amount of data for that data frame at a correspondingly reduced power level.

4. The method of claim 3, wherein each data frame has a duration of less than 20 milliseconds.

5. The method of claim 4, wherein each data frame comprises:
downlink control channel information defining the modulation-coding level at which data for that data frame will be transmitted from the base station to the remote station;
downlink data;
uplink control channel information defining the modulation-coding level at which data for that data frame will be transmitted from the remote station to the base station; and
uplink data.

6. The method of claim 5, wherein both the base station wireless transmitter and the remote station wireless transmitter transmit at any of at least 36 discrete transmission power levels selected for that data frame, and using any of at least nine modulation-coding levels selected for that data frame.

7. The method of claim 1, wherein each data frame has a duration of less than 20 milliseconds, and wherein the act of assessing an amount of data being transmitted in each data frame is performed anew for each data frame.

8. The method of claim 7, wherein the power level and modulation-coding level can be adjusted each data frame.

9. A method of transmitting data in a fixed wireless communication network, comprising:
assessing the amount of data to be transmitted in a data frame, the data frame having a duration of less than four seconds;
receiving an indication of signal quality;
establishing, based on the indication of signal quality, a highest modulation-coding level selected from at least four modulation-coding levels at which data can be adequately transmitted;
determining for each data frame a power level and modulation-coding level which:
a) when the amount of data being transmitted in that data frame requires the highest adequate modulation-coding level, is at the highest optimal power level; and
b) when the amount of data being transmitted in that data frame requires less than the highest adequate modulation-coding level, is at a lower modulation-coding level sufficient to transmit the amount of data for that data frame and at a correspondingly reduced power level;
transmitting control channel information indicating the determined modulation-coding level being used for that data frame; and
transmitting data for that data frame at the determined modulation-coding level and determined power level.

10. The method of claim 9, wherein an amount of corresponding reduction of power level is based on the decibel difference in signal quality permitted by the lower modulation-coding level.

11. The method of claim 9, wherein each data frame has a duration of less than 20 milliseconds, and wherein each data frame comprises:
control channel information defining the modulation-coding level at which data for that data frame will be transmitted;
transmission data;
reception control channel information indicating the signal quality of a preceding transmission; and
received data.

12. The method of claim 9, wherein data transmission can occur at any of at least 36 discrete transmission power levels selected for that data frame, and using any of at least nine modulation-coding levels selected for that data frame.

13. The method of claim 9, wherein each data frame has a duration of less than 20 milliseconds, and wherein the act of assessing an amount of data being transmitted in each data frame is performed anew for each data frame.

14. The method of claim 13, wherein the power level and modulation-coding level can be adjusted each data frame.

15. A device for communicating in a fixed wireless communication network, comprising:
a wireless transmitter which can transmit at any of at least four discrete transmission power levels selected for a data frame having a duration less than four seconds, and using any of at least four modulation-coding levels selected for that data frame; and
a receiver which can receive an indication of wireless signal quality from a prior transmission from the wireless transmitter;
wherein the wireless transmitter transmits:
control channel information indicating the modulation-coding level being used for that data frame; and
transmission data, with the transmission data being transmitted for each data frame at a power level and modulation-coding level which:
a) when an amount of data being transmitted in that data frame requires the highest adequate modulation-coding level based upon the indication of wireless signal quality, is at the highest optimal power level; and
b) when the amount of data being transmitted in that data frame requires less than the highest adequate modulation-coding level, is at a lower modulation-coding level sufficient to transmit the amount of data for that data frame and at a correspondingly reduced power level.

16. The device of claim 15, provided in a base station which can independently control the wireless transmitter with any of a plurality of simultaneously connected remote units.

17. The device of claim 15, provided in a remote unit.

18. The device of claim 15, wherein data transmission can occur at any of at least 36 discrete transmission power levels selected for that data frame, and using any of at least nine modulation-coding levels selected for that data frame.

19. The device of claim 18, wherein each data frame has a duration of less than 20 milliseconds, and wherein an amount of data being transmitted in each data frame is assessed anew for each data frame.

20. The device of claim 19, wherein the power level and modulation-coding level can be adjusted each data frame.
